(19) United States
(12) Patent Application Publication
(10) Pub. No.: US 2024/0144732 A1
(43) Pub. Date: May 2, 2024

(54) Method and System of Independent Assessments of Toll Road Systems and Operations

(71) Applicant: VeriToll LLC, Ashburn, VA (US)

(72) Inventors: Joseph C. Silva, Las Vegas, NV (US); Miguel A. Calles, La Habra, CA (US)

(21) Appl. No.: 17/975,307

(22) Filed: Oct. 27, 2022

(51) Int. Cl. G07B 15/06

(52) U.S. Cl. CPC G07B 15/06

(57) ABSTRACT

The system and method of the present invention allows the present invention to independently assess the performance of toll points and toll road operations by using data provided by driver accounts, confirming data with surveys, analyzing data by review processes, and rewarding data sharing with incentives. The present invention gathers data and information about various toll points throughout test routes. The method creates a driver account with a license plate, toll transponder number, and vehicle data. The method then provides information about a test route assigned to the driver. The test route is a driving pathway that passes through at least one toll point allowing the driver mobile device to collect data about the at least one toll point. The method then collects and processes test route data from the driver and then generates a plurality of insights. The method then evaluates the test route data by a review process.

### FIELD OF THE INVENTION

The present invention relates generally to independently assessing a toll road and toll road operations. More specifically, present invention processes public and proprietary driver-provided and toll system data to check for heath and accuracy of the toll road locations.

### BACKGROUND OF THE INVENTION

Toll roads have multiple systems and components to make a toll road operational. There are roadside systems, back-office system, billing systems, reporting systems, customer call center systems, websites, and possibly others. All these systems have their individual components (e.g., sensors on the road, payment integrations, databases, etc.). One system alone is complex and integrating various systems in a workflow increases the complexity. Being able to assess the wellbeing and functionality of these systems can be just as complex.

In general, there are two types of toll road systems: closed-road and open-road toll roads. Their roadside systems have different components. Closed-road systems are designed to prevent a vehicle from entering or exiting the toll road without valid payment. Open-road systems are designed to allow all vehicles to use the toll road and the toll is billed later. Both systems have their own complexities. Different assessment methods are needed to ensure both types of systems are functioning properly.

For many organizations, the assessments are done by internal processes or by the systems manufacturers. There is a risk that either party will default to the easiest assessment method over the most thorough. There is also a risk that either party may choose assessment results that are meant to bring positive light to the organization. This might be influenced that bad assessment results may result in job loss or contracts not being renewed. These biases and fears may prevent the toll road agencies from getting the most accurate and thorough assessments of their tolling assets.

### BRIEF DESCRIPTION OF THE DRAWINGS

FIG. 1 is an illustration of an online platform consistent with various embodiments of the present disclosure.

FIG. 2 is a block diagram of a computing device for implementing the methods disclosed herein, in accordance with some embodiments.

FIG. 3 is an illustration of a flowchart of the present invention.

FIG. 4 is an illustration of a flowchart of the present invention.

FIG. 5 is an illustration of a flowchart of the present invention.

FIG. 6 is an illustration of a flowchart of the present invention.

FIG. 7 is an illustration of a flowchart of the present invention.

FIG. 8 is an illustration of a flowchart of the present invention.

FIG. 9 is an illustration of a flowchart of the present invention.

FIG. 10 is an illustration of a flowchart of the present invention.

FIG. 11 is an illustration of a flowchart of the present invention.

FIG. 12 is an illustration of a flowchart of the present invention.

FIG. 13 is an illustration of a flowchart of the present invention.

FIG. 14 is an illustration of a flowchart of the present invention.

FIG. 15 is an illustration of a flowchart of the present invention.

FIG. 16 is an illustration of a flowchart of the present invention.

FIG. 17 is an illustration of a flowchart of the present invention.

FIG. 18 is an illustration of a flowchart of the present invention.

FIG. 19 is an illustration of a flowchart of the present invention.

FIG. 20 is an illustration of a flowchart of the present invention.

FIG. 21 is an illustration of a flowchart of the present invention.

FIG. 22 is an illustration of a flowchart of the present invention.

FIG. 23 is an illustration of a flowchart of the present invention.

FIG. 24 is a block diagram of the system of the present invention.

FIG. 25 is an illustration of the fidelity and confidence ratings of the present invention.

### DETAIL DESCRIPTIONS OF THE INVENTION

All illustrations of the drawings are for the purpose of describing selected versions of the present invention and are not intended to limit the scope of the present invention.

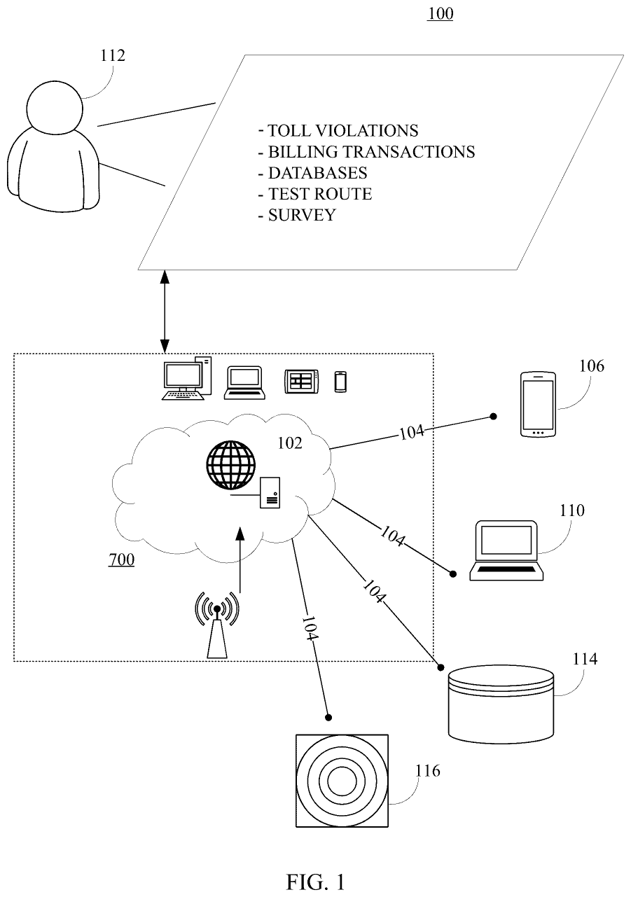

FIG. 1 is an illustration of an online platform 100 consistent with various embodiments of the present disclosure. By way of non-limiting example, the online platform 100 to enable facilitating management of driver location data and relevant data may be hosted on a centralized server 102, such as, for example, a cloud computing service. The driver location data and relevant data may include but are not limited to GPS location, timestamps of the driver on a test route, direction of travel of the driver, license plate of the driver, the toll road transponder associated with the driver, classification and number of axles of the automotive vehicle associated with the driver, signals captured from the toll transponder, software executions generated by the automotive vehicle associated with the driver and database records generated by an automotive vehicle associated with the driver. The centralized server 102 may communicate with other network entities, such as, for example, a mobile device 106 (such as a smartphone, a laptop, a tablet computer, in-vehicle infotainment system, a standalone hardware unit, etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

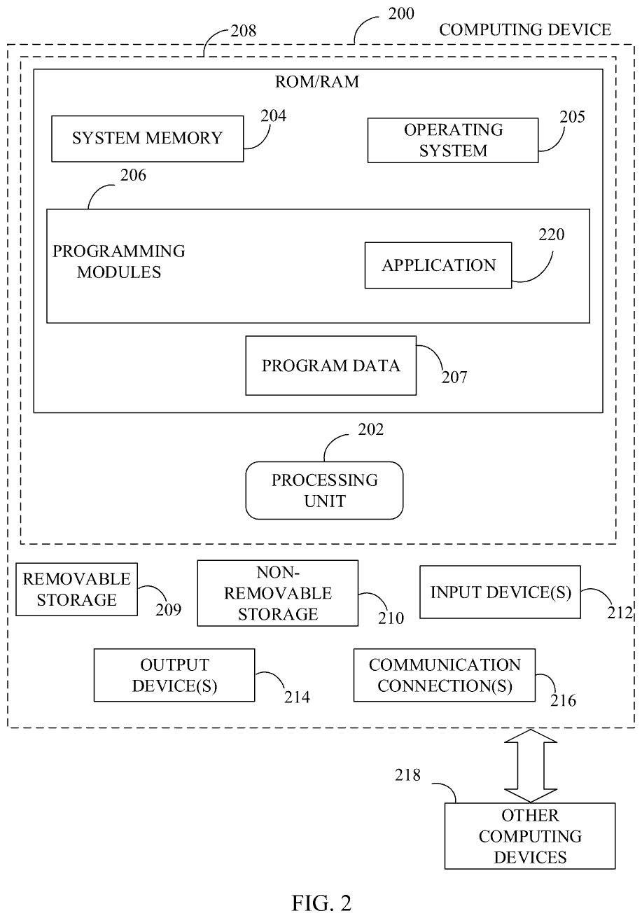

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, artificial intelligence and machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage mediums (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning and artificial intelligence applications.

As can be seen in FIG. 1 through FIG. 25, the preferred embodiment of the present invention is a method and system for independently assessing a toll road and toll operations. The method of the present invention accesses public and proprietary data sources and data from partners to create toll transaction records to compare against the toll system data. A toll transaction is an electronic record of a toll and a related set of transponder information and/or license plate information and/or images that passes through a specific toll point. The toll point is the physical location and equipment where a transponder and/or license plate information is read, and a toll transaction is created. Additionally, the method and system plans test routes, estimates toll prices, drives on the toll road, and monitors payment processes. The method of the present invention analyzes various sources of data to assess a toll road system and the associated toll road operations. For example, the present invention can utilize individual drivers to pass through toll points along various test routes in order to check and monitor a variety of factors and key performance indicators associated with at least one toll point along a test route. A key performance indicator is an indicator, metric or number that shows the progress toward a desired result or outcome. In this way, the method and system of the present invention collects data pertaining to toll systems and processes the information to provide an overall assessment about the toll system to a toll agency. The toll agency is a public or private entity that has the authority to charge tolls for road usage and owns, manages or operates a toll road.

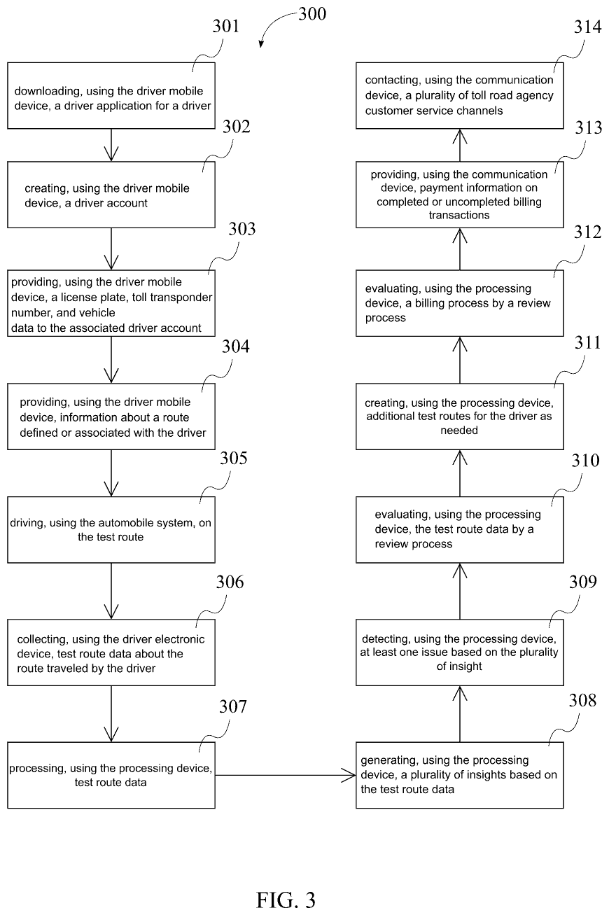

As can be seen in FIG. 3, the system 2400 used to execute the method 300 of the present invention allows the present invention to gather data and information about various toll points throughout test routes. To accomplish this, the method of the present invention may include a step 301 of downloading, using the driver mobile device 2111, a driver application for a driver. The driver application is a mobile application that can execute various functions with a graphical user interface that allows the driver to easily navigate various features available on the driver application. The driver mobile device 2111 being a portable electronic device associated with the driver capable of internet connection and capability. The system 2400 used to execute the method of the present invention may include a step 302 of creating, using the driver mobile device 2111, a driver account. The driver account is an online account within the driver application that is associated with a driver. The system 2400 used to execute the method of the present invention may include a step 303 of providing, using the driver mobile device 2111, a license plate, toll transponder number, and vehicle data to the associated driver account. The toll transponder number is an identification number that is associated with a toll transponder that communicates with a toll road lane sensor 2140. The vehicle data provided by the driver is information such as vehicle make, vehicle color, vehicle model, vehicle classification, number of axles, etc. The system 2400 used to execute the method of the present invention may include a step 304 of providing, using the driver mobile device 2111, information about a test route defined or associated with the driver. The test route is a driving pathway that passes through at least one toll point allowing the driver mobile device 2111 to collect data about the at least one toll point. The system 2400 used to execute the method of the present invention may include a step 305 of driving, using the automobile system 2110, on the test route. The automobile system 2110 is the automotive vehicle associated with the driver and driver account capable of driving through a toll point. For example, a driver can download the driver application from their preferred mobile application store, setting up an account and filling out information about their automotive vehicle. After creating their driver account the driver is then provided a visual representation of the test route on a map with directions and then proceeds to follow the pathway presented by the test route. The driver account may capture test data even when no test route was assigned.

As can be seen in FIG. 3, the system 2400 used to execute the method 300 of the present invention allows the present invention to execute at least one test route and analyze the test route data gathered. To accomplish this, the method of the present invention may include a step 306 of collecting, using the driver electronic device 2112, test route data about the test route traveled by the driver. The driver electronic device 2112 is an electronic device that connects various physical components together allowing them to communicate such as the toll transponder, the automotive vehicle, in-vehicle systems, roadside sensors and physical hardware (communication radios, beacons, etc.). The test route data may include but is not limited to, toll transactions, billing transactions, traffic counts, and collection records. The billing transaction is the record of the payment of toll price due posted to a toll billing account. The toll billing account being an account managed by the toll road agency and associated with the driver enabling the driver to pay toll billing transactions and see the toll billing statement. The system 2400 used to execute the method of the present invention may include a step 307 of processing, using the processing device 2130, test route data. The processing device 2130 allows the test route data to be used to evaluate various aspects of the toll road operations. The system 2400 used to execute the method of the present invention may include a step 308 of generating, using the processing device 2130, a plurality of insights based on the test route data. The insights generated provide an overall idea of the strengths and weaknesses of the toll road operations. The system 2400 used to execute the method of the present invention may include a step 309 of detecting, using the processing device 2130, at least one issue based on the plurality of insights. The issues may include areas where the toll road operations have inconsistencies, reoccurring mistakes, or failures. The system 2400 used to execute the method of the present invention may include a step 310 of evaluating, using the processing device 2130, the test route data by a review process. The review process is preferably conducted by one or more individuals with backgrounds in data analyzation and the transportation industry that can take the test route data (whether in its raw form or analyzed by artificial intelligence (AI) or machine learning (ML) or other algorithms) and create meaningful conclusions. The review process is designed to increase the fidelity and confidence of the data obtained. Continuing the previous example, a test case may evaluate whether a test route was billed in the toll road invoice, or the test case may evaluate the estimated toll price listed on the toll road's website matches the actual billed toll price in the toll road invoice. Furthermore, AI and ML algorithms for example, may detect unexpected drops in toll transactions and revenue and misclassified vehicles for a toll point, which could then be analyzed by the review process to determine a failed toll equipment.

As can be seen in FIG. 3, the system 2400 used to execute the method 300 of the present invention allows the present invention to evaluate the billing process and customer service provided by the toll agency. The billing process is the steps taken to collect the payment for a toll billing transaction. To accomplish this, the method of the present invention may include a step 311 of creating, using the processing device 2130, additional test routes for the driver as needed. The additional test routes could be the exact same as the initial test route or could provide the driver with a different path to drive along. The system 2400 used to execute the method of the present invention may include a step 312 of evaluating, using the processing device 2130, a billing process by the review process. The review process will evaluate specific data pin-pointed by the AI and ML algorithms to detect any deficiencies. The system 2400 used to execute the method of the present invention may include a step 313 of providing, using the communication device 2120, payment information on completed or uncompleted billing transactions. The payment information contains details of the payment which includes but not limited to amount, date, time, and payment method. The communication device 2120 allows the driver to easily interact with the processing device 2130 and toll road lane sensor 2140 through their driver mobile device 2111 and driver electronic device 2112. The system 2400 used to execute the method of the present invention may include a step 314 of contacting, using the communication device 2120, plurality of toll road agency customer service channels. The plurality of toll road agency customer service channels are direct communication paths from the toll agency to the driver designed to resolve any issues encountered by the driver. For example, customer satisfaction scores could unexpectedly increase, which could indicate a process change implemented at the toll road agency customer service channels was effective and the data gathered can provide metrics supporting this claim. For example, invoice records could be used to determine how many days on average it takes for a toll trip to appear on the invoice. Another example, test routes on the toll road that failed to appear on the invoice could be used to generate a missed toll transactions rate. Any data may be processed in various other ways as needed. For example, the collected data may be used to draw a process flow chart that describes how call center interactions within the agency service centers are handled. Another example, the collected data may be used to create a heat map of the toll point reliabilities. Another example, location and vehicle information collected by internal data sources and data partners may be used to reconstruct a toll road trip and create a test trip toll transaction record for comparison with toll road system data. Data will be collected and processed to provide a thorough and independent assessment of the toll road operations and customer experience.

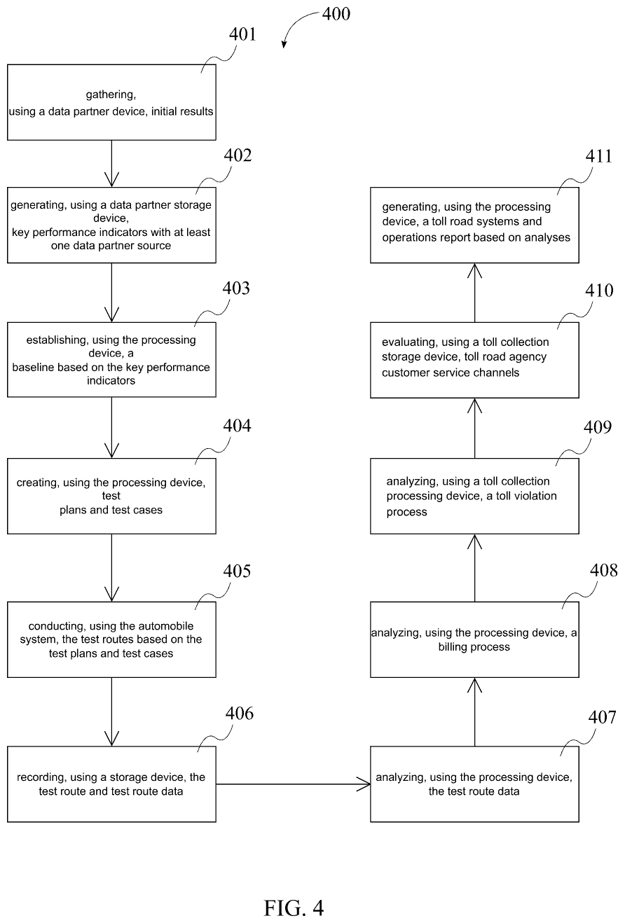

In reference to FIG. 4, a sub-process method 400 of the present invention enables the present invention to record and analyze test route data. To that end, the sub-process begins with a step 401 by gathering, using a data partner device 2160, initial results. The data partner device is an electronic device that collects the initial results that are a compilation of data that may be publicly available, proprietary, provided by the toll road system, generated by the invention or acquired from data partners. The sub-process continues with a step 402 by generating, using a data partner storage device 2161, key performance indicators with at least one data partner source. The data partner storage device (removable or non-removable) stores data from at least one data partner source. The data partner source is a data source that provides information to allow various metrics to be determined to effectively run the test routes and gather test route data. The sub-process continues with a step 403 by establishing, using the processing device 2130, a baseline based on the key performance indicators. The baseline provides a control standard that can be compared to later on after a test route is completed. The sub-process continues with a step 404 by creating, using the processing device 2130, test plans and test cases. The test plans and test cases contain a plurality of test routes for drivers while considering various factors to achieve effective data. The sub-process continues with a step 405 by conducting, using the automobile system 2110, the test routes based on the test plans and test cases. The sub-process continues with a step 406 by recording, using a storage device 2131, the test route and test route data. The storage device 2131 is an electronic device designed for performing data storage or data retrieval operations. The sub-process continues with a step 407 by analyzing, using the processing device 2130, the test route data. The sub-process continues with a step 408 by analyzing, using the processing device 2130, a billing process. The sub-process continues with a step 409 by analyzing, using a toll collection processing device 2151, a toll violation process. The toll collection processing is an electronic device capable of analyzing the toll violation process. The toll violation process is the steps the toll agency takes when a driver passes through a toll point and does not complete the proper payment method necessary to pass through the toll point. The sub-process continues with a step 410 by evaluating, using a toll collection storage device 2152, toll road agency customer service channels. The toll collection storage device 2152 is an electronic device capable of data storage and data retrieval the primarily stores information on the backend of the toll agency such as toll transactions and billing history. The sub-process continues with a step 411 by generating, using the processing device 2130, a toll road systems and operations report based on analyses. The data is aggregated and synthesized by the review process or the AI/ML algorithms where can then be displayed in various ways. The toll road systems and operations report provides a summary and key results that presents detailed findings in tabular and visual formats that can be downloaded or saved in a graphical file format. Returning again to the example, the toll road systems and operations report can send alerts that highlight a specific section of data within the toll point analysis, sent through electronic communications (e.g., email, messaging system, push notifications) or through audio communications.

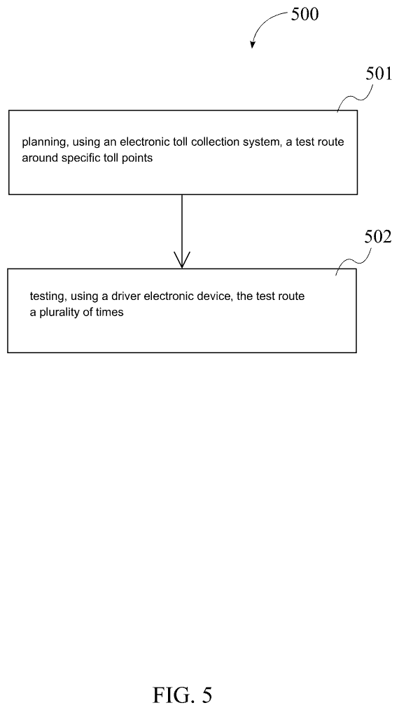

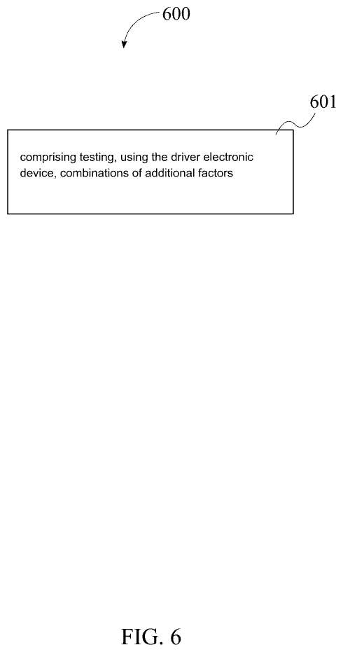

In reference to FIG. 5, a sub-process method 500 of the present invention enables test routes to be executed multiple times to test various factors ensuring accuracy. To that end, the sub-process begins with a step 501 by planning, using an electronic toll collection system 2150, a test route around specific toll points. The electronic toll collection system 2150 is an electronic device associated with a toll agency that allows for interaction from the roadside equipment of the toll agency. Furthermore, a driver can drive along a path without selecting a specific test route and the driver location data and relevant data will still be recorded and a test route trip be detected. The sub-process continues with a step 502 by testing, using a driver electronic device 2112, the test route a plurality of times. The test route is executed more than one time to ensure consistency in the test route data being gathered. The next sub-process method 600 continues with a step 60 by testing, using the driver electronic device 2112, combinations of additional factors shown in FIG. 6. The toll agency can determine if additional test routes are needed with additional factors creating a different test route, allowing the driver to encounter various circumstances when completing the test route. For example, a driver may complete one test route and then drive the test route again in the opposite direction, without a proper toll transponder, or with any other varying factor that would influence the test route data received once the test route is completed by the driver.

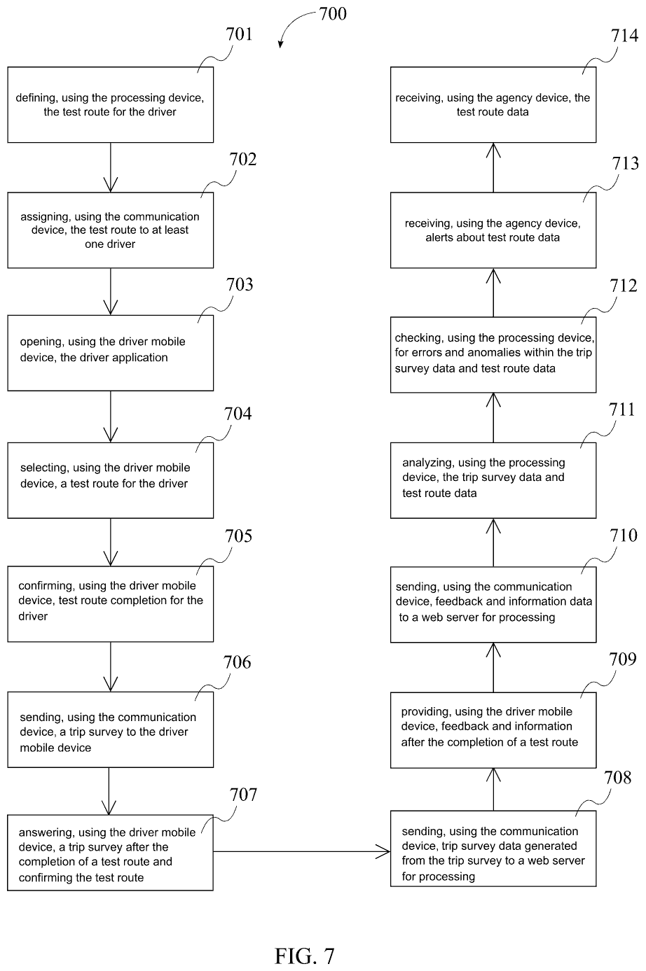

In reference to FIG. 7, a sub-process method 700 of the present invention enables the driver to be assigned to a test route and provide their opinion on the test route once complete. To that end, the sub-process begins with a step 701 by defining, using the processing device 2130, the test route for the driver. The processing device 2130 creates a visual representation of the test route for a driver to follow. The sub-process continues with a step 702 by assigning, using the communication device 2120, the test route to at least one driver. The communication device 2120 then sends the test route to at least one driver mobile device 2111 allowing multiple drivers to test the same test route under slightly different circumstances. A test route does not need to be assigned to a driver in order for the driver to collect data about the trip completed. The sub-process continues with a step 703 by opening, using the driver mobile device 2111, the driver application. The sub-process continues with a step 704 by selecting, using the driver mobile device 2111, a test route for the driver. The sub-process continues with a step 705 by confirming, using the driver mobile device 2111, test route completion for the driver. The sub-process continues with a step 706 by sending, using the communication device 2120, a trip survey to the driver mobile device 2111. The trip survey is an online document with a list of questions pertaining to the test route and how the test route was conducted and completed by the driver. The sub-process continues with a step 707 by answering, using the driver mobile device 2111, the trip survey about the test route. The sub-process continues with a step 708 by sending, using the communication device 2120, trip survey data generated from the trip survey to a web server for processing. This allows the trip survey data to be stored and easily accessible for analyzation. The sub-process continues with a step 709 by analyzing, using the processing device 2130, the trip survey data and test route data. The sub-process continues with a step 710 by checking, using the processing device 2130, for errors and anomalies within the trip survey data and test route data. The anomalies can include but are not limited to unusual increases/decreases in the collected test data, discrepancies among the test data, and discrepancies when comparing the test data to toll system data. The sub-process continues with a step 711 by receiving, using the electronic toll collection system 2150, alerts about test route data. The alerts can be designed as any visual or audio notification that is sent to the electronic toll collection system 2150 with an associated test route data. The sub-process continues with a step 712 by receiving, using the electronic toll collection system 2150, the test route data. Returning again to the example, the alerts could show that key performance indicators have fallen below a minimum threshold or have exceeded a maximum threshold, detected anomalies and their detailed information, gaps in test data, detected failures, etc.

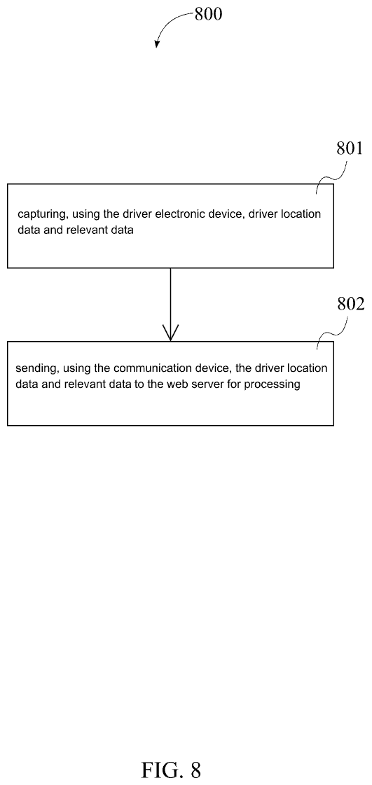

In reference to FIG. 8, a sub-process method 800 of the present invention enables monitoring of driver location data and relevant data. To that end, the sub-process begins with a step 801 by capturing, using the driver electronic device 2112, driver location data and relevant data. The sub-process continues with a step 802 by sending, using the communication device 2120, the driver location data and relevant data to the web server for processing. This allows the driver location data and relevant data to be used by the processing device 2130 to generate conclusions about the effectiveness of each toll point.

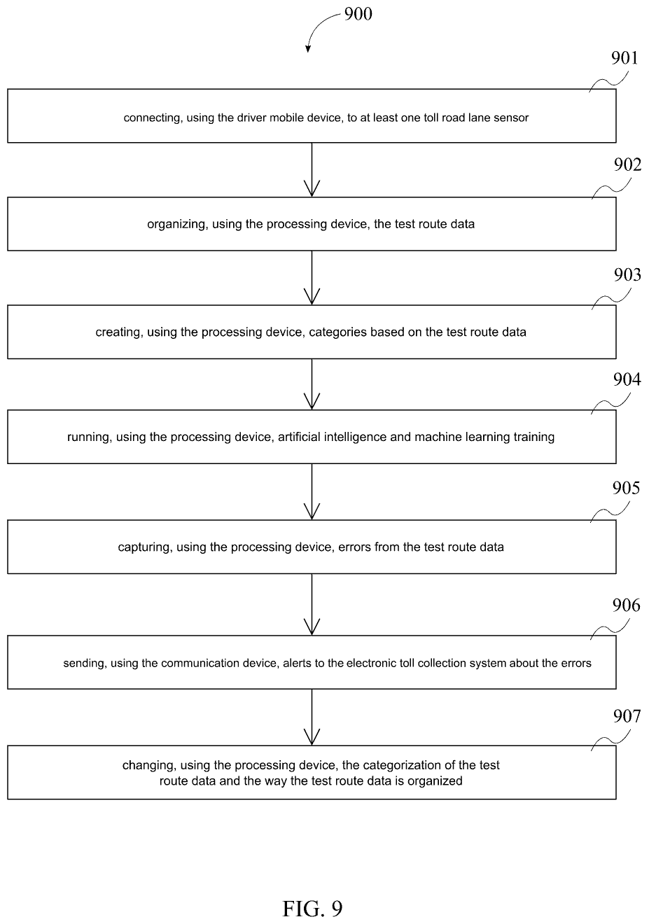

In reference to FIG. 9, a sub-process method 900 of the present invention enables AI and ML algorithms to analyze test route data gathered from a toll road lane sensor 2140 and driver mobile device 2111. To that end, the sub-process begins with a step 901 by connecting, using the driver mobile device 2111, to at least one toll road lane sensor 2140. The toll road lane sensor 2140 is an electronic system that monitors the driver electronic device 2112 passing through a toll point. The sub-process continues with a step 902 by organizing, using the processing device 2130, the test route data. The sub-process continues with a step 903 by creating, using the processing device 2130, categories based on the test route data. The test route data is organized and categorized in various ways such as the size of the test route data, the quantity of test route data collected, the accuracy of the test route data, the number of issues within a timeframe, amongst various other organizational methods. The sub-process continues with a step 904 by running, using the processing device 2130, artificial intelligence and machine learning training. The artificial intelligence and machine learning automatically compares incoming test route data with stored test route data with matching criteria to determine any inconsistencies and potential errors. The sub-process continues with a step 905 by capturing, using the processing device 2130, errors from the test route data. The sub-process continues with a step 906 by sending, using the communication device 2120, alerts to the electronic toll collection system 2150 about the errors. This provides the electronic toll collection system 2150 with a highlighted section of the test route data that is erroneous and potentially the result of a problem. The sub-process continues with a step 907 by changing, using the processing device 2130, the categorization of the test route data and the way the test route data is organized. Returning again to the example, a driver is constantly monitored by at least one toll road lane sensor 2140 at every toll point where the driver location data and relevant data is then sent and processed by the AI and ML algorithms to ensure an issue such as an incorrect toll transponder is not being improperly used by a driver.

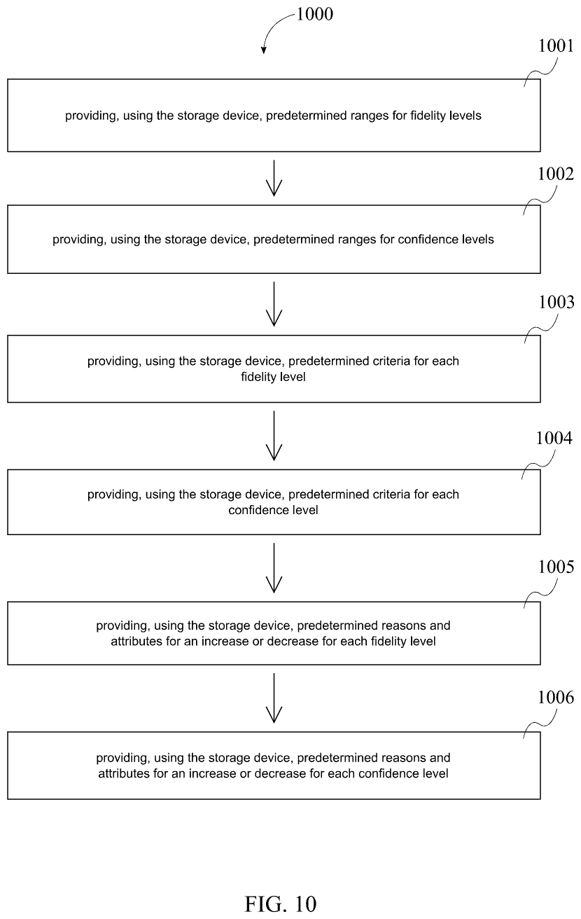

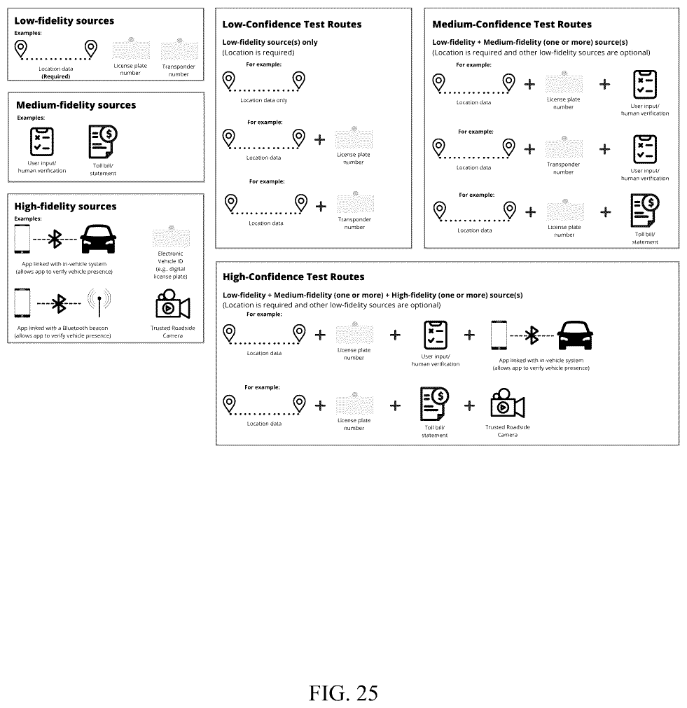

In reference to FIG. 10, a sub-process method 1000 of the present invention enables data to be categorized based on fidelity and confidence. To that end, the sub-process begins with a step 1001 by providing, using the storage device 2131, predetermined ranges for fidelity levels. The sub-process continues with a step 1002 by providing, using the storage device 2131, predetermined ranges for confidence levels. The sub-process continues with a step 1003 by providing, using the storage device 2131, predetermined criteria for each fidelity level. The sub-process continues with a step 1004 by providing, using the storage device 2131, predetermined criteria for each confidence level. The sub-process continues with a step 1005 by providing, using the storage device 2131, predetermined reasons and attributes for an increase or decrease for each fidelity level. The sub-process continues with a step 1006 by providing, using the storage device 2131, predetermined reasons and attributes for an increase or decrease for each confidence level. Returning again to the example, if a fidelity level range is set to high, medium and low and a high confidence level is set to a range of 90-100, if a driver provides lots of information and data and their data matches up with data provided by the toll agency in every scenario the driver location data and relevant data would then have a high-fidelity level and a high confidence level of 90-100. An example of fidelity level ranges, fidelity criteria, confidence ranges, and confidence criteria are shown in FIG. 25.

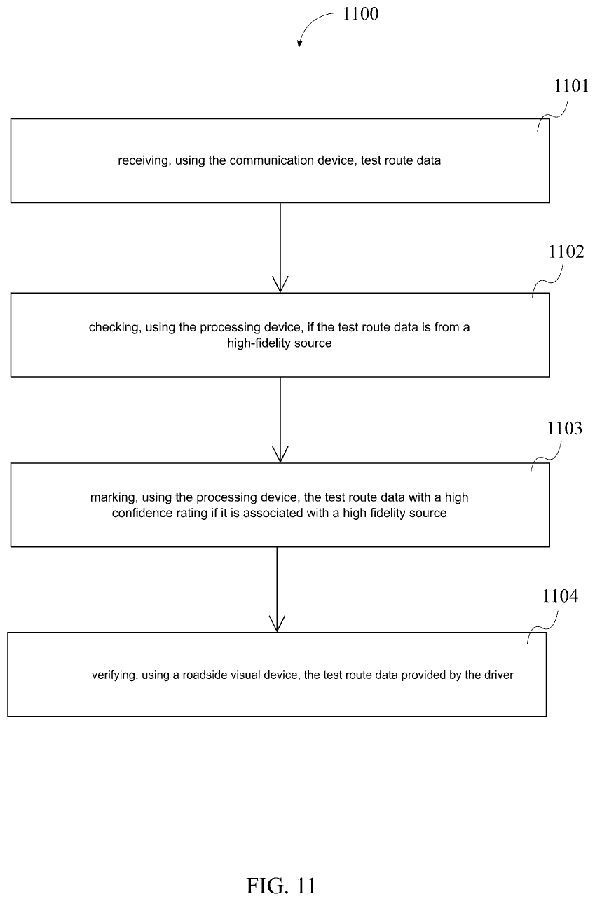

In reference to FIG. 11, a sub-process method 1100 of the present invention enables high-fidelity sources for test route data to be marked and organized. To that end, the sub-process begins with a step 1101 by receiving, using the communication device 2120, test route data. The sub-process continues with a step 1102 by checking, using the processing device 2130, if the test route data is from a high-fidelity source. The test route data is considered a high-fidelity source if the driver application has a radio frequency connection such as to the vehicle system or with a Bluetooth beacon confirming the vehicle the driver is currently using. Additionally, test route data confirmed by a roadside visual device such as a trusted roadside camera will categorize the test route data as high-fidelity. The sub-process continues with a step 1103 by marking, using the processing device 2130, the test route data with a high confidence rating if it is associated with a high-fidelity source. The test route data will have an associated high confidence if the high-fidelity source is confirmed along with a medium fidelity source and a low fidelity source. A medium-fidelity source is test route data from user input, verification, or a toll statement. A low-fidelity source is the required location data or a license plate number or transponder number. The sub-process continues with a step 1104 by verifying, using a roadside visual device, the test route data provided by the driver. The roadside visual device is a camera or recording device that monitors the driver on a trip to provide visual verification of a driver on a test route. The roadside visual device is designed to increase fidelity and confidence of the driver location data and relevant data. When the test route data matches and is verified by toll agency data or other means the test route data is then considered high confidence.

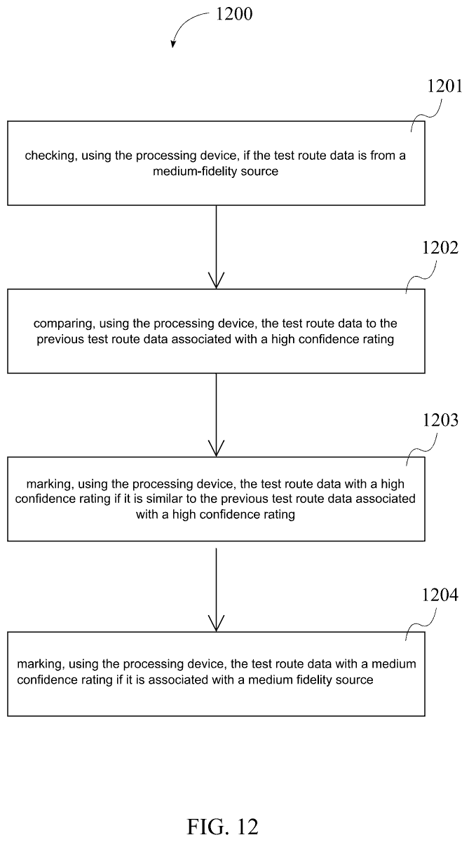

In reference to FIG. 12, a sub-process method 1200 of the present invention enables medium-fidelity sources for test route data to be marked and organized with either medium or high confidence levels. To that end, the sub-process begins with a step 1201 by checking, using the processing device 2130, if the test route data is from a medium-fidelity source. A medium-fidelity source is when the driver confirms the data source being provided with user input or human verification or provides a toll statement. The sub-process continues with a step 1202 by comparing, using the processing device 2130, the test route data to the previous test route data associated with a high confidence rating. The medium-fidelity source is then compared to the high-fidelity source to check for similarities in the data source. The sub-process continues with a step 1203 by marking, using the processing device 2130, the test route data with a high confidence rating if it is similar to the previous test route data associated with a high confidence rating. The sub-process continues with a step 1204 by marking, using the processing device 2130, the test route data with a medium confidence rating if it is associated with a medium fidelity source and a low fidelity source.

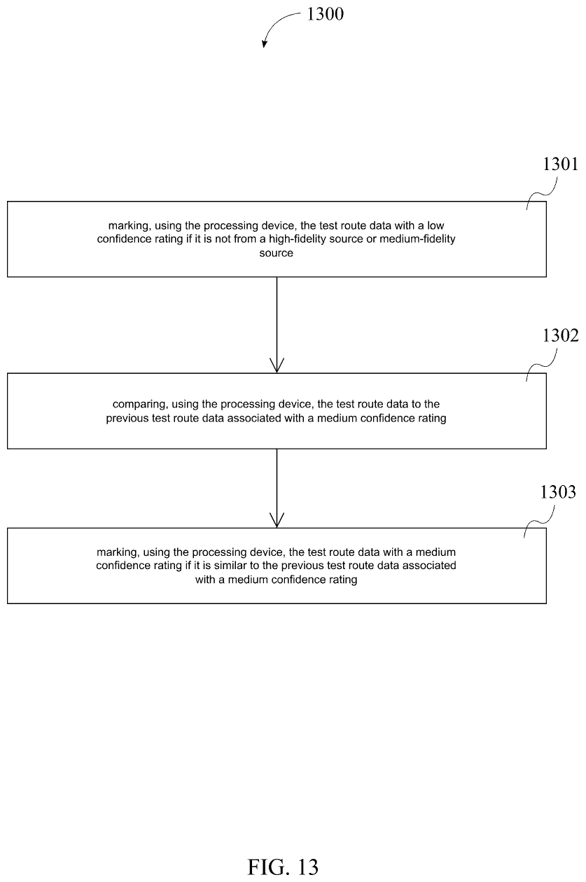

In reference to FIG. 13, a sub-process method 1300 of the present invention enables low-fidelity sources for test route data to be marked and organized with either low or medium confidence. To that end, the sub-process begins with a step 1301 by marking, using the processing device 2130, the test route data with a low confidence rating if it is not from a high-fidelity source or medium-fidelity source. A low-fidelity source is where the driver provides only driver location data, a license plate number, or a transponder number. The sub-process continues with a step 1302 by comparing, using the processing device 2130, the test route data to the previous test route data associated with a medium confidence rating. The sub-process continues with a step 1303 by marking, using the processing device 2130, the test route data with a medium confidence rating if it is similar to the previous test route data associated with a medium confidence rating.

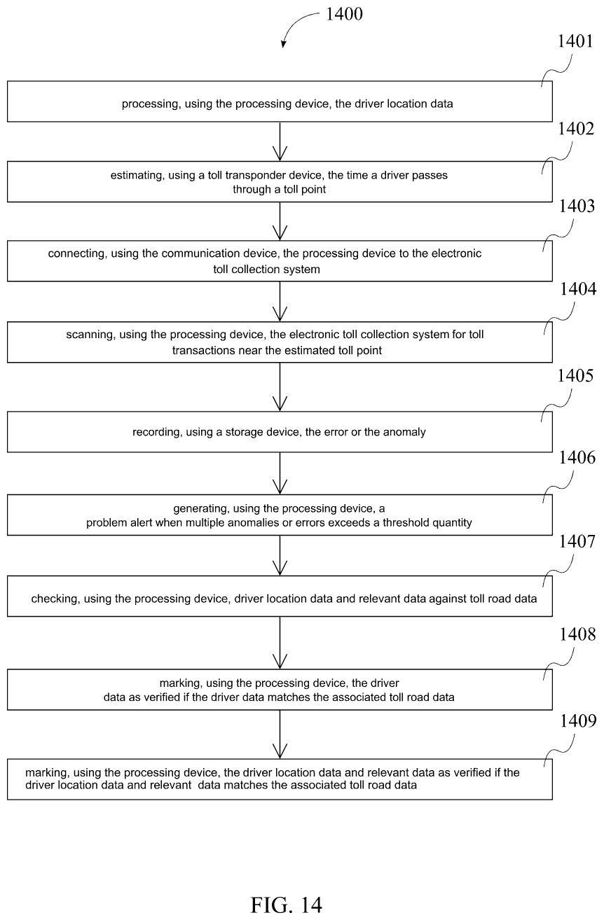

In reference to FIG. 14, a sub-process method 1400 of the present invention enables driver test route data to be compared to toll route data. To that end, the sub-process begins with a step 1401 by processing, using the processing device 2130, the driver location data. The sub-process continues with a step 1402 by estimating, using a toll transponder device 2113, the time a driver passes through a toll point. The toll transponder device 2113 is an electric device that sends information to the nearby toll road lane sensor 2140 scanning the toll transponder device 2113. The sub-process continues with a step 1403 by connecting, using the communication device 2120, the processing device 2130 to the electronic toll collection system 2150. The sub-process continues with a step 1404 by scanning, using the processing device 2130, the electronic toll collection system 2150 for toll transactions near the estimated toll point. The sub-process continues with a step 1405 by recording, using a storage device 2131, the error or the anomaly. The sub-process continues with a step 1406 by generating, using the processing device 2130, a problem alert when multiple anomalies or errors exceeds a threshold quantity. The threshold is a predetermined amount that when exceeded, in the case of errors and anomalies, an alert is sent to the electronic toll collection system 2150. The sub-process continues with a step 1407 by checking, using the processing device 2130, driver location data and relevant data against toll road data. Toll road data contains but is not limited to toll transactions, billing transactions, and any data collected by the toll road agency systems and devices. The sub-process continues with a step 1408 by marking, using the processing device 2130, the driver location data and relevant data as verified if the driver location data and relevant data matches the associated toll road data. Once the driver location data and relevant data is cross-checked with the toll road data the toll agency can have a higher confidence that that driver location data and relevant data is accurate. The sub-process continues with a step 1409 by generating, using the processing device 2130, a health score for the toll point. The health score being a number that provides a visual and concrete value for the number of checks that passed compared to the total number checks. For example, if a toll point at a certain toll location shows a significant drop off in toll transactions for one day compared to others in the area, resulting in multiple anomalies being noted, an alert would be sent to the electronic toll collection system 2150 associated with the toll agency, pinpointing a potential problem at the location of the toll point.

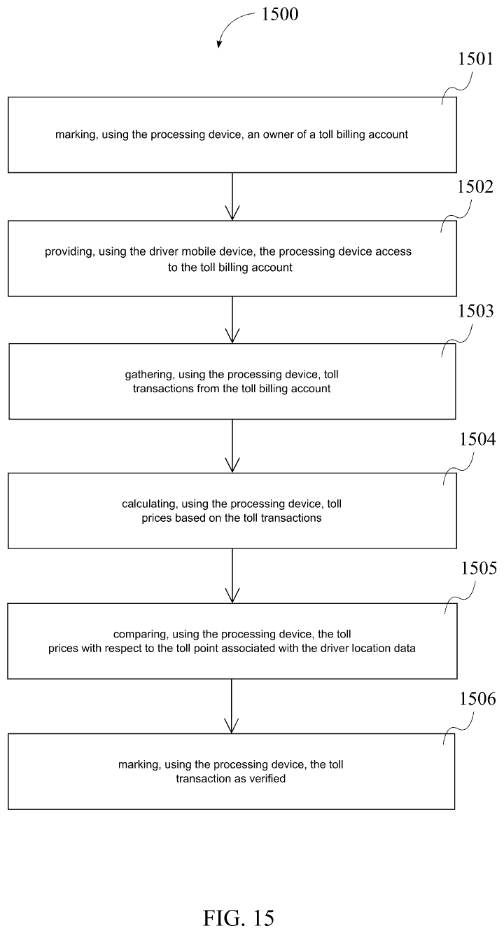

In reference to FIG. 15, a sub-process method 1500 of the present invention enables data to be retrieved from toll billing accounts. To that end, the sub-process begins with a step 1501 by marking, using the processing device 2130, an owner of a toll billing account. The owner being the driver utilizing the automotive vehicle passing through the toll point. The sub-process continues with a step 1502 by providing, using the driver mobile device 2111, the processing device 2130 access to the toll billing account. The sub-process continues with a step 1503 by gathering, using the processing device 2130, toll transactions from the toll billing account. The sub-process continues with a step 1504 by calculating, using the processing device 2130, toll prices based on the toll transactions. The toll price is the cost a driver must pay for passing through a toll point. The sub-process continues with a step 1505 by comparing, using the processing device 2130, the toll prices with respect to the toll point associated with the driver location data. This ensures that the two price numbers are the same, indicating a properly working toll transaction at the specific toll point. The sub-process continues with a step 1506 by marking, using the processing device 2130, the toll transaction as verified. For example, if a driver passed through a toll point and is charged $1.50 while the toll point price is supped to be $1.25 the toll transaction is not marked as verified and is flagged for further investigation.

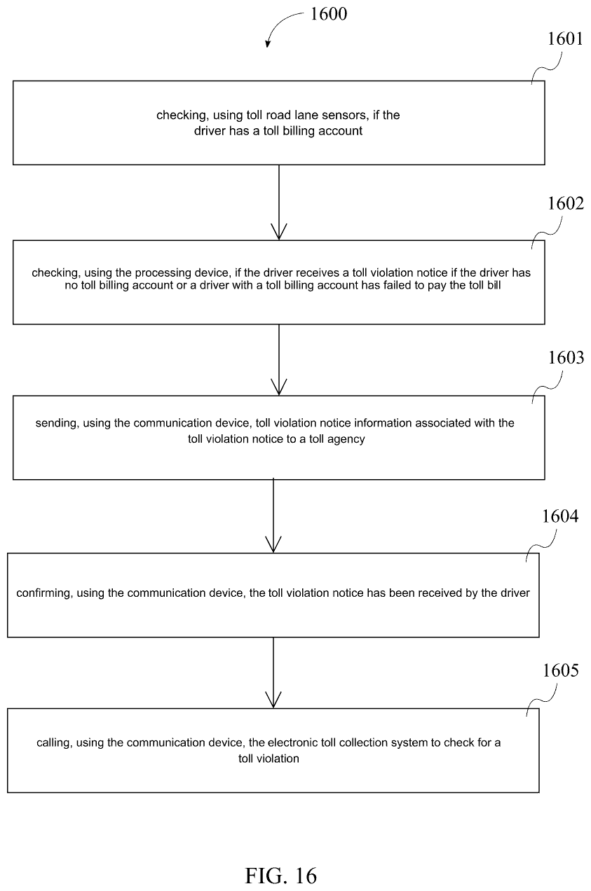

In reference to FIG. 16, a sub-process method 1600 of the present invention checks the toll violation process of toll transactions. To that end, the sub-process begins with a step 1601 by checking, using toll road lane sensors 2140, if the driver has a toll billing account. The toll road sensors are electronic devices that scan the surrounding area for a toll transponder. The sub-process continues with a step 1602 by checking, using the processing device 2130, if the driver receives a toll violation notice if the driver has no toll billing account or a driver with a toll billing account has failed to pay the toll bill. The toll violation being a physical or digital document, documenting the toll infraction and requesting payment. The sub-process continues with a step 1603 by sending, using the communication device 2120, toll violation notice information associated with the toll violation notice to a toll agency. The toll violation information includes details such as, but not limited to, full name, unpaid toll price amounts, fines, license plate, and vehicle information. The sub-process continues with a step 1604 by confirming, using the communication device, the toll violation notice has been received by the driver. The sub-process continues with a step 1605 by calling, using the communication device, the electronic toll collection system to check for a toll violation.

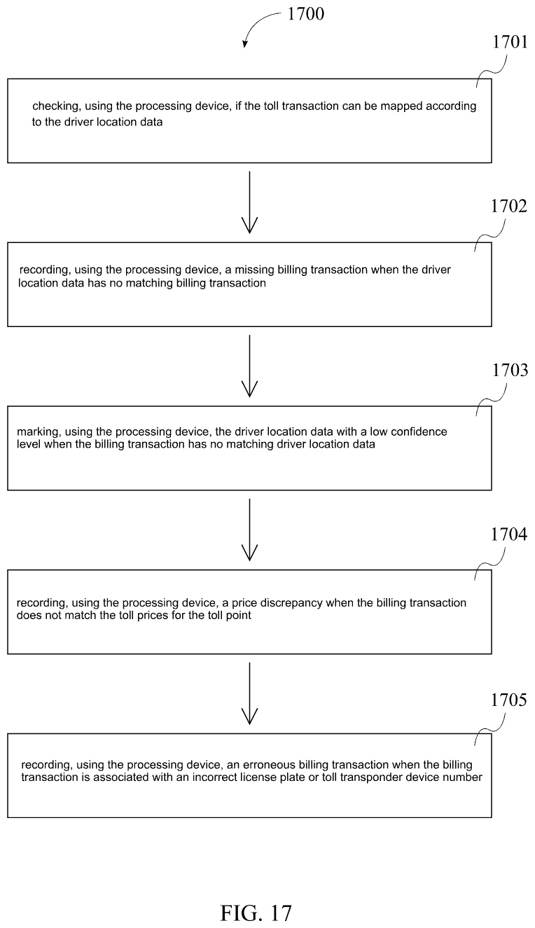

In reference to FIG. 17, a sub-process method 1700 of the present invention enables tracking of toll transactions. To that end, the sub-process begins with a step 1701 by checking, using the processing device 2130, if the toll transaction can be mapped according to the driver location data. This pinpoints each toll transaction to a specific location on a map to document and visualize toll transactions. The sub-process continues with a step 1702 by recording, using the processing device 2130, a missing billing transaction when the driver location data has no matching billing transaction. The sub-process continues with a step 1703 by marking, using the processing device 2130, the driver location data with a low confidence level when the billing transaction has no matching driver location data. This ensures that the driver location data can be properly organized based on confidence level. The sub-process continues with a step 1704 by recording, using the processing device 2130, a price discrepancy when the billing transaction does not match the toll prices for the toll point. The price discrepancy is a number that is the difference between the toll price on the billing transaction and the toll point. The sub-process continues with a step 1705 by recording, using the processing device 2130, an erroneous billing transaction when the billing transaction is associated with an incorrect license plate or toll transponder device 2113 number. For example, if a driver passes through a toll point without paying and another driver is billed with the toll transaction, the present invention will cross-check vehicle details with driver location data at that point to ensure the proper driver is charged. Erroneous billing transactions are discrepancies such as overcharging, undercharging, charged by vehicle/axle misclassification, omitted/missing billing transaction, charged to an incorrect license plate or transponder number, and multiple/duplicate charging.

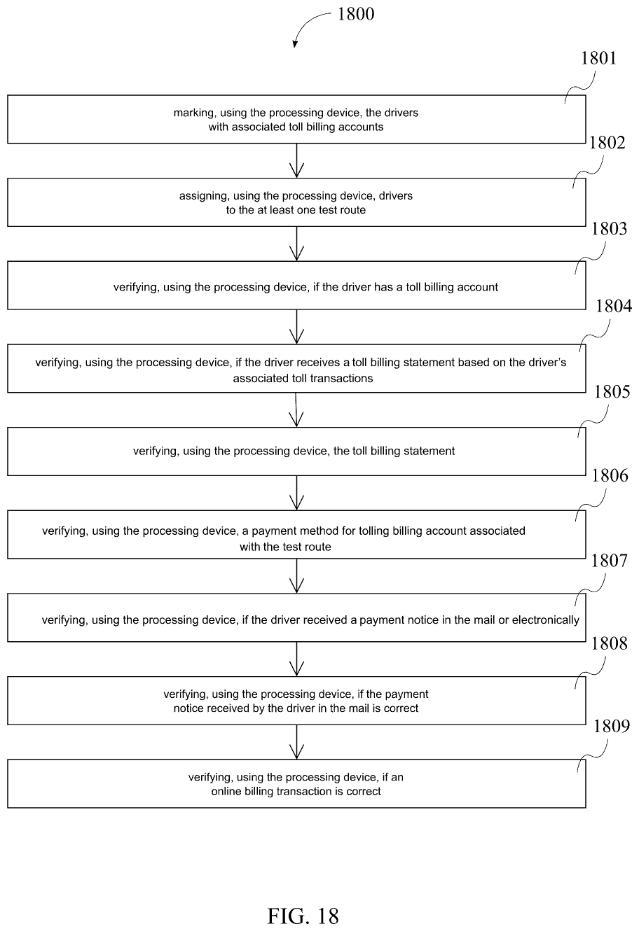

In reference to FIG. 18, a sub-process method 1800 of the present invention enables drivers to be checked to ensure proper toll billing accounts and methods of payment. To that end, the sub-process begins with a step 1801 by marking, using the processing device 2130, the drivers with associated toll billing accounts. The toll billing account being an online account associated with the driver enabling the driver to pay toll transactions. The sub-process continues with a step 1802 by assigning, using the processing device 2130, drivers to the at least one test route. The sub-process continues with a step 1803 by verifying, using the processing device 2130, if the driver has a toll billing account. The sub-process continues with a step 1804 by verifying, using the processing device 2130, if the driver receives a toll billing statement based on the driver's associated toll transactions. The toll billing statement is a physical or electronic document listing all the toll billing transactions and toll prices. This checks to make sure the driver is being charged for the specific toll points the driver passes through. The sub-process continues with a step 1805 by verifying, using the processing device 2130, the toll billing statement. The sub-process continues with a step 1806 by verifying, using the processing device 2130, a payment method for the test route. The payment method being either a physical payment or electronic payment. The sub-process continues with a step 1807 by verifying, using the processing device 2130, if the driver received a payment notice in the mail. The payment notice is a physical or electronic document describing the unpaid balance for a toll billing account. The processing device 2130 checks to ensure the driver is billed. The sub-process continues with a step 1808 by verifying, using the processing device 2130, if the payment notice received by the driver in the mail is correct. The sub-process continues with a step 1809 by verifying, using the processing device 2130, if a billing transaction is correct.

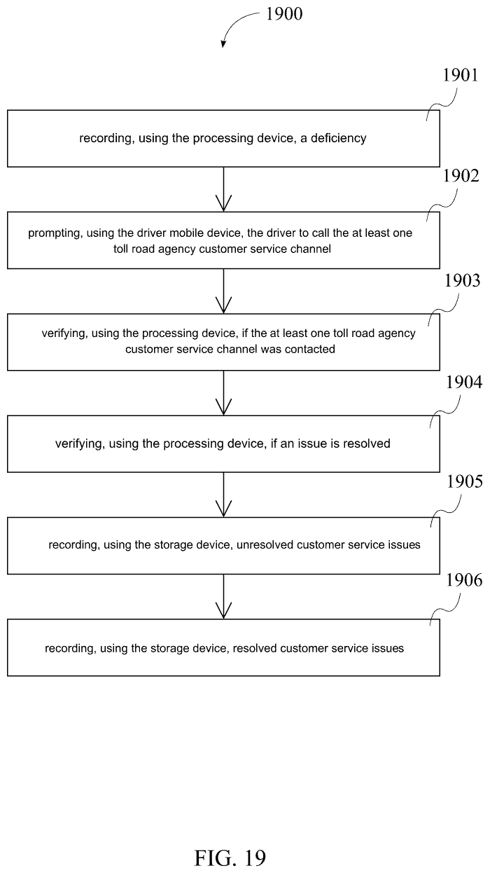

In reference to FIG. 19, a sub-process method 1900 of the present invention enables drivers to voice concerns about the toll process. To that end, the sub-process begins with a step 1901 by recording, using the processing device 2130, a deficiency. The deficiency being, but not limited to, any sort of toll transaction error, billing error, or complaint about the toll agency. The sub-process continues with a step 1902 by prompting, using the driver mobile device 2111, the driver to call the at least one toll road agency customer service channel. The toll road agency customer service channel being a call center or online service center designed to address and solve problems. The sub-process continues with a step 1903 by verifying, using the processing device 2130, if the at least one toll road agency customer service channel was contacted. The sub-process continues with a step 1904 by verifying, using the processing device 2130, if an issue is resolved. The sub-process continues with a step 1905 by recording, using the storage device 2131, unresolved customer service issues. The sub-process continues with a step 1906 by recording, using the storage device 2131, resolved customer service issues. This ensures that all issues, resolved or unresolved, are properly logged and monitored to allow the toll agency to see where they can improve in customer-service relations.

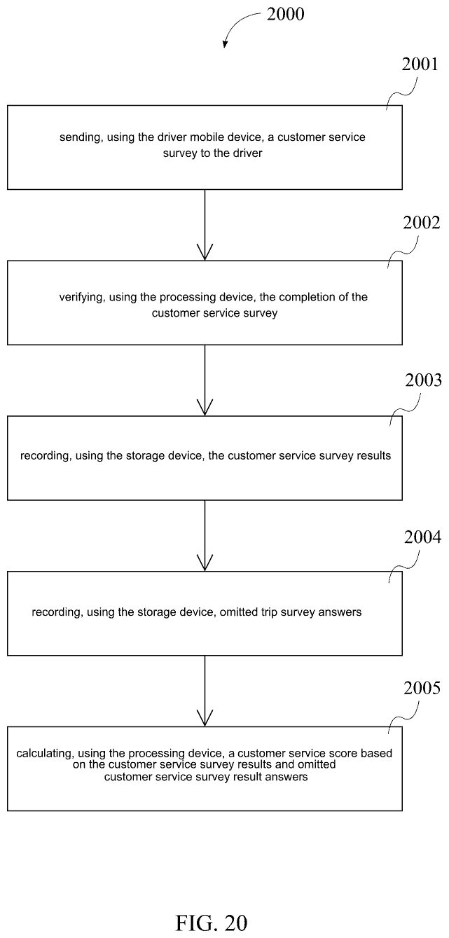

In reference to FIG. 20, a sub-process method 2000 of the present invention provides the drivers with a trip survey to rate the toll road agency customer service channels. To that end, the sub-process begins with a step 2001 by sending, using the driver mobile device 2111, a customer service survey to the driver. The sub-process continues with a step 2001 by verifying, using the processing device 2130, the completion of the customer service survey. The sub-process continues with a step 2003 by recording, using the storage device 2131, the customer service survey results. The sub-process continues with a step 2004 by recording, using the storage device 2131, omitted trip survey answers. The sub-process continues with a step 2005 by calculating, using the processing device 2130, a customer service score based on the customer service survey results and omitted customer service survey result answers. The customer service score being a number that provides a visual and concrete value for the effectiveness of the toll road agency customer service channel.

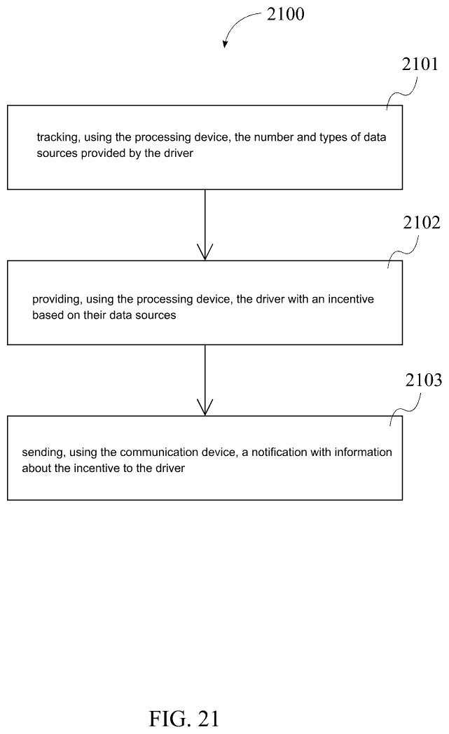

In reference to FIG. 21, a sub-process method 2100 of the present invention provides the drivers with an incentive for providing multiple data sources. To that end, the sub-process begins with a step 2101 by tracking, using the processing device 2130, the number and types of data sources provided by the driver. The data sources primarily consist of GPS location data and test route data but can include various types of information such as license information, driving information, vehicle information, trip survey information, amongst various other information. The incentive is a reward for the driver such as a monetary gain. The sub-process continues with a step 2102 by providing, using the processing device, the driver with an incentive based on their data sources. This is designed to increase the amount of data received to increase fidelity. The incentive is primarily a monetary amount for the driver but can consist of any benefit for the driver. The driver receives the incentive when providing vehicle information such as a license plate number, the issuing state, the vehicle classification, the number of axles, amongst other information. Further, the incentive can be linked to the driver completing a trip survey related to the test route data and qualitative information about the road and test route. Furthermore, the driver provides information about the toll bill, toll transaction information, and real-time information relating to issues and incidents. The driver can then verify data provided by other drivers for additional incentives, increasing the overall fidelity of the system. The sub-process finishes with a step 2103 by sending, using the communication device, a notification with information about the incentive to the driver. For example, the driver might receive a notification on their driver mobile device indicating that they received an extra $2.20 for providing their vehicle information and completing a trip survey.

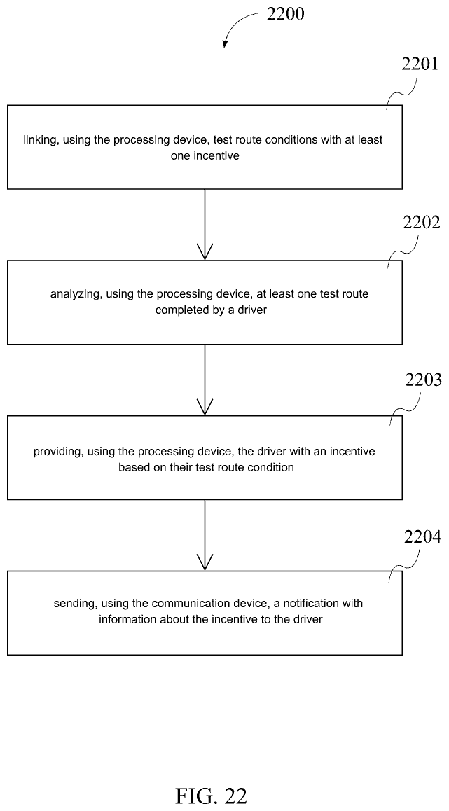

In reference to FIG. 22, a sub-process method 2200 of the present invention provides the drivers with an incentive for traveling during certain traffic conditions. To that end, the sub-process begins with a step 2201 by linking, using the processing device, test route conditions with at least one incentive. The test route condition is an alteration of the test route such as heavy traffic, a specific exit, a stop close to a specific event, a route along construction, etc. The test route condition can indicate a desired time window to increase usage during less busy times or to relieve traffic congestion. The test route condition can indicate a driver to drive at a certain speed such as driving close to the speed limit or below the speed limit to observe work zone speed limits. The test route condition can further indicate the driver to use a toll road instead of a free road, drive to a specific location such as a specific store, or to drive in a specific lane at a toll point. The sub-process continues with a step 2202 by analyzing, using the processing device, at least one test route completed by a driver. The sub-process continues with a step 2203 by providing, using the processing device, the driver with an incentive based on their test route condition. The sub-process finishes with a step 2204 by sending, using the communication device, a notification with information about the incentive to the driver. For example, if the driver takes a specific exit and travels along attest route with current road construction, the driver receives an extra $1.40 for following the specific test route conditions.

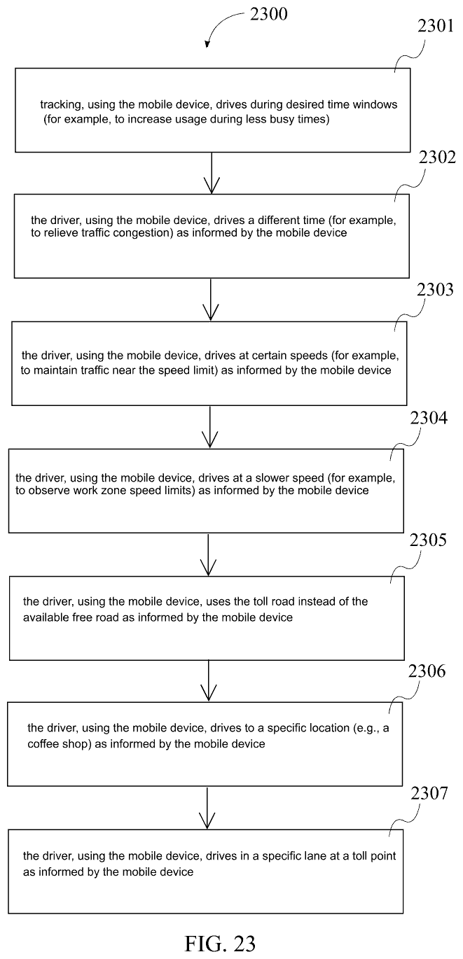

In reference to FIG. 23, a sub-process method 2300 of the present invention provides the drivers with an incentive for traveling during certain traffic conditions. To that end, the sub-process begins with a step 2301 by tracking, using the mobile device, drives during desired time windows (for example, to increase usage during less busy times). The sub-process continues with a step 2302 by the driver, using the mobile device, drives a different time (for example, to relieve traffic congestion) as informed by the mobile device. The sub-process continues with a step 2303 by the driver, using the mobile device, drives at certain speeds (for example, to main traffic near the speed limit) as informed by the mobile device. The sub-process continues with a step 2304 by the driver, using the mobile device, drives at a slower speed (for example, to observe work zone speed limits) as informed by the mobile device. The sub-process continues with a step 2305 by the driver, using the mobile device, uses the toll road instead of the available free road as informed by the mobile device. The sub-process continues with a step 2306 by the driver, using the mobile device, drives to a specific location (e.g., a coffee shop) as informed by the mobile device. The sub-process continues with a step 2307 by the driver, using the mobile device, drives in a specific lane at a toll point as informed by the mobile device.

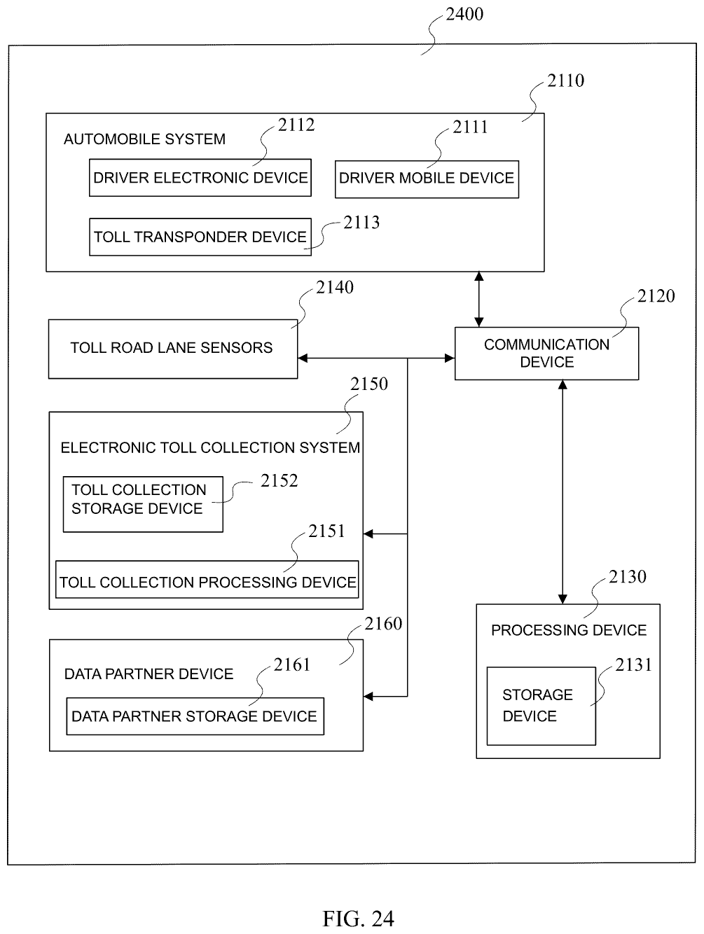

FIG. 24, illustrates a block diagram of a system 2400 for the independent assessments of toll road systems and operations, in accordance with some embodiments. The toll road systems and operations is the people, processes and technology required to operate the toll road. Accordingly, the system may include a communication device 2120. Further the communication device 2120 may be configured for providing payment information on completed or uncompleted billing transactions. Further the communication device 2120 may be configured for contacting the plurality of toll road agency customer service channels. Further the communication device 2120 may be configured for assigning the test route to at least one driver. Further the communication device 2120 may be configured for sending a trip survey to the driver mobile device 2111. Further the communication device 2120 may be configured for sending trip survey data generated from the trip survey to a web server for processing. Further the communication device 2120 may be configured for sending the driver location data and relevant data to the web server for processing. Further the communication device 2120 may be configured for sending alerts to the electronic toll collection system 2150 about the errors. Further the communication device 2120 may be configured for receiving test route data. Further the communication device 2120 may be configured for sending toll violation notice information associated with the toll violation notice to a toll agency. Further, the system may include a driver mobile device 2111 communicatively coupled with the communication device 2120. Further the driver mobile device 2111 may be configured for downloading a driver application for a driver. Further the driver mobile device 2111 may be configured for creating a driver account. Further the driver mobile device 2111 may be configured for providing a license plate, toll transponder number, and vehicle data to the associated driver account. Further the driver mobile device 2111 may be configured for providing information about a test route assigned to the driver. Further the driver mobile device 2111 may be configured for opening the driver application. Further the driver mobile device 2111 may be configured for selecting a test route for the driver. Further the driver mobile device 2111 may be configured for confirming test route completion for the driver. Further the driver mobile device 2111 may be configured for answering the trip survey about the test route. Further the driver mobile device 2111 may be configured for connecting to at least one toll road lane sensor 2140. Further the driver mobile device 2111 may be configured for providing the processing device 2130 access to the toll billing account. Further the driver mobile device 2111 may be configured for prompting the driver to call the at least one toll road agency customer service channels. Further the driver mobile device 2111 may be configured for prompting the driver to call the at least one toll road agency customer service channels. Further the driver mobile device 2111 may be configured for sending a customer service survey to the driver.

As shown in FIG. 24, the system may include an automobile system 2110 communicatively coupled with the communication device 2120. Further, the communication device 2120 may be configured for providing information about a test route assigned to the driver. Further, the communication device 2120 may be further configured for conducting the test routes based on the test plans and test cases. Further, the system may include a driver electronic device 2112 communicatively coupled with the communication device 2120. Further, the driver electronic device 2112 may be configured for collecting test route data about the test route traveled by the driver. Further, the driver electronic device 2112 may be configured for testing the test route, a plurality of times. Further, the driver electronic device 2112 may be configured for testing combinations of additional factors. Further, the driver electronic device 2112 may be configured for capturing driver location data and relevant data.

As seen in FIG. 24, the system may include a processing device 2130 communicatively coupled with the communication device 2120. Further, the processing device 2130 may be configured for processing test route data. Further, the processing device 2130 may be configured for generating a plurality of insights based on the test route data. Further, the processing device 2130 may be configured for detecting at least one issue based on the plurality of insights. Further, the processing device 2130 may be configured for evaluating the test route data by a review process. The review process is designed to increase the fidelity and confidence of the data obtained. Further, the processing device 2130 may be configured for creating additional test routes for the driver as needed. Further, the processing device 2130 may be configured for evaluating a billing process by the review process. Further, the processing device 2130 may be configured for establishing a baseline based on the key performance indicators. Further, the processing device 2130 may be configured for creating test plans and test cases. Further, the processing device 2130 may be configured for organizing the test route data. Further, the processing device 2130 may be configured for creating categories based on the test route data. Further, the processing device 2130 may be configured for running artificial intelligence and machine learning training. Further, the processing device 2130 may be configured for capturing errors from the test route data. Further, the processing device 2130 may be configured for changing the categorization of the test route data and the way the test route data is organized. Further, the processing device 2130 may be configured for checking if the test route data is from a high-fidelity source. Further, the processing device 2130 may be configured for marking the test route data with a high confidence rating if it is associated with a high-fidelity source. Further, the processing device 2130 may be configured for checking if the test route data is from a medium fidelity source. Further, the processing device 2130 may be configured for comparing the test route data to the previous test route data associated with a high confidence rating. Further, the processing device 2130 may be configured for marking the test route data with a high confidence rating if it is similar to the previous test route data associated with a high confidence rating. Further, the processing device 2130 may be configured for marking the test route data with a medium confidence rating if it is associated with a medium fidelity source. Further, the processing device 2130 may be configured for marking the test route data with a low confidence rating if it is not from a high-fidelity source or medium-fidelity source. Further, the processing device 2130 may be configured for comparing the test route data to the previous test route data associated with a medium confidence rating. Further, the processing device 2130 may be configured for marking the test route data with a medium confidence rating if it is similar to the previous test route data associated with a medium confidence rating. Further, the processing device 2130 may be configured for marking an owner of a toll billing account. Further, the processing device 2130 may be configured for gathering toll transactions from the toll billing account. Further, the processing device 2130 may be configured for calculating toll prices based on the toll transactions. Further, the processing device 2130 may be configured for comparing the toll prices with respect to the toll point associated with the driver location data. Further, the processing device 2130 may be configured for marking the toll transaction as verified. Further, the processing device 2130 may be configured for checking if the driver receives a toll violation notice if the driver has no toll billing account or a driver with a toll billing account has failed to pay the toll bill. Further, the processing device 2130 may be configured for checking if the toll transaction can be mapped according to the driver location data. Further, the processing device 2130 may be configured for recording a missing billing transaction when the driver location data has no matching billing transaction. Further, the processing device 2130 may be configured for marking the driver location data with a low confidence level when the billing transaction has no matching the driver location data. Further, the processing device 2130 may be configured for recording a price discrepancy when the billing transaction does not match the toll prices for the toll point. Further, the processing device 2130 may be configured for recording an erroneous billing transaction when the billing transaction is associated with an incorrect license plate or toll transponder device 2113 number. Further, the processing device 2130 may be configured for marking the drivers with associated toll billing accounts. Further, the processing device 2130 may be configured for assigning drivers to the at least one test route. Further, the processing device 2130 may be configured for verifying if the driver has a toll billing account. Further, the processing device 2130 may be configured for verifying if the driver receives a toll billing statement based on the driver's associated toll transactions. Further, the processing device 2130 may be configured for verifying the toll billing statement. Further, the processing device 2130 may be configured for verifying a payment method for the test route. Further, the processing device 2130 may be configured for verifying if the driver received a payment notice in the mail. Further, the processing device 2130 may be configured for verifying if the payment notice received by the driver in the mail is correct. Further, the processing device 2130 may be configured for verifying if a billing transaction is correct. Further, the processing device 2130 may be configured for recording a deficiency. Further, the processing device 2130 may be configured for verifying if the at least one toll road agency customer service channels was contacted. Further, the processing device 2130 may be configured for verifying if an issue is resolved. Further, the processing device 2130 may be configured for verifying the completion of the customer service survey. Further, the processing device 2130 may be configured for calculating a customer service score based on the customer service survey results and omitted customer service survey result answers.

As seen in FIG. 24, the system may include a data partner device 2160 communicatively coupled with the communication device 2120. Further, the data partner device 2160 may be configured for gathering initial results. Further, the data partner device 2160 may be configured for analyzing the test route data. Further, the data partner device 2160 may be configured for analyzing a billing process. Further, the data partner device 2160 may be configured for generating a toll road systems and operations report based on analyses. Further, the data partner device 2160 may be configured for defining the test route for the driver. Further, the data partner device 2160 may be configured for analyzing the trip survey data and test route data. Further, the data partner device 2160 may be configured for checking for errors and anomalies within the trip survey data and test route data. Further, the system may include a data partner storage device 2161 communicatively coupled with the data partner device 2160. Further, the data partner storage device 2161 may be configured for generating key performance indicators with at least one data partner source. Further, the system may include a storage device 2131 communicatively coupled with the communication device 2120. Further, the storage device 2131 may be configured for recording the test route and test route data. Further, the storage device 2131 may be configured for providing predetermined ranges for fidelity levels. Further, the storage device 2131 may be configured for providing predetermined ranges for confidence levels. Further, the storage device 2131 may be configured for providing predetermined criteria for each fidelity level. Further, the storage device 2131 may be configured for providing predetermined criteria for each confidence level. Further, the storage device 2131 may be configured for providing predetermined reasons and attributes for an increase or decrease for each fidelity level. Further, the storage device 2131 may be configured for providing predetermined reasons and attributes for an increase or decrease for each confidence level.

As seen in FIG. 24, the system may include an electronic toll collection system 2150 communicatively coupled with the communication device 2120. Further, the toll collection storage device 2152 may be configured for planning a test route around specific toll points. Further, the toll collection storage device 2152 may be configured for receiving alerts about test route data. Further, the toll collection storage device 2152 may be configured for receiving the test route data. Further, the toll collection storage device 2152 may be configured for recording unresolved customer service issues. Further, the toll collection storage device 2152 may be configured for recording resolved customer service issues. Further, the toll collection storage device 2152 may be configured for recording the customer service survey results. Further, the toll collection storage device 2152 may be configured for recording omitted trip survey answers. Furthermore, the system may include a toll collection processing device 2151 communicatively coupled with the electronic toll collection system 2150. Further, the toll collection processing device 2151 may be configured for analyzing a toll violation process. Furthermore, the system may include a toll collection storage device 2152 communicatively coupled with the electronic toll collection system 2150. Further, the toll collection storage device 2152 may be configured for evaluating a plurality of toll road agency customer service channels. Further, the system may include a toll road lane sensor communicatively coupled with a toll road lane sensor 2140 that is communicatively coupled with the communication device 2120. Further, the toll road lane sensor may be configured for checking if the driver has a toll billing account.

Although the invention has been explained in relation to its preferred embodiment, it is to be understood that many other possible modifications and variations can be made without departing from the spirit and scope of the invention as hereinafter claimed.

What is claimed is:

1. A method of independent assessments of toll road systems and operations comprising the steps of:
downloading, using the driver mobile device, a driver application for a driver;
creating, using the driver mobile device, a driver account;
providing, using the driver mobile device, a license plate, toll transponder number, and vehicle data to the associated driver account;
providing, using the driver mobile device, information about a route defined or associated with the driver;
driving, using the automobile system, on the test route;
collecting, using the driver electronic device, test route data about the route traveled by the driver;
processing, using the processing device, test route data;
generating, using the processing device, plurality of insights based on the test route data;
detecting, using the processing device, at least one issue based on the plurality of insights;
evaluating, using the processing device, the test route data by a review process;
creating, using the processing device, additional test routes for the driver as needed;
evaluating, using the processing device, a billing process by a review process;
providing, using the communication device, payment information on completed or uncompleted billing transactions; and
contacting, using the communication device, plurality of toll road agency customer service channel.

2. The method of independent assessments of toll road systems and operations as claimed in claim 1 comprising:
gathering, using a data partner device, initial results;
generating, using a data partner storage device, key performance indicators with at least one data partner source;
establishing, using the processing device, a baseline based on the key performance indicators;
creating, using the processing device, test plans and test cases;
conducting, using the automobile system, the test routes based on the test plans and test cases;
recording, using a storage device, the test route and test route data;
analyzing, using the processing device, the test route data;
analyzing, using the processing device, a billing process;
analyzing, using a toll collection processing device, a toll violation process;
evaluating, using a toll collection storage device, toll road agency customer service channels; and
generating, using the processing device, a toll road systems and operations report based on analyses.

3. The method of independent assessments of toll road systems and operations as claimed in claim 2 comprising:
planning, using an electronic toll collection system, a test route around specific toll points; and
testing, using a driver electronic device, the test route a plurality of times.

4. The method of independent assessments of toll road systems and operations as claimed in claim 3 comprising testing, using the driver electronic device, combinations of additional factors.

5. The method of independent assessments of toll road systems and operations as claimed in claim 1 comprising:
defining, using the processing device, the test route for the driver;
assigning, using the communication device, the test route to at least one driver;
opening, using the driver mobile device, the driver application;
selecting, using the driver mobile device, a test route for the driver;
confirming, using the driver mobile device, test route completion for the driver;
sending, using the communication device, a trip survey to the driver mobile device;
answering, using the driver mobile device, a trip survey after the completion of a test route and confirming the test route;
sending, using the communication device, trip survey data generated from the trip survey to a web server for processing;
providing, using the driver mobile device, feedback and information after the completion of a test route;
sending, using the communication device, feedback and information data to a web server for processing;
analyzing, using the processing device, the trip survey data and test route data;
checking, using the processing device, for errors and anomalies within the trip survey data and test route data;
receiving, using the electronic toll collection system, alerts about test route data; and
receiving, using the electronic toll collection system, the test route data.

6. The method of independent assessments of toll road systems and operations as claimed in claim 5 comprising:
capturing, using the driver electronic device, driver location data and relevant data; and
sending, using the communication device, the driver location data and relevant data to the web server for processing.

7. The method of independent assessments of toll road systems and operations as claimed in claim 1 comprising:
connecting, using the driver mobile device, to at least one toll road lane sensor;
organizing, using the processing device, the test route data;
creating, using the processing device, categories based on the test route data;
running, using the processing device, artificial intelligence and machine learning training;
capturing, using the processing device, errors from the test route data;
sending, using the communication device, alerts to the electronic toll collection system about the errors; and
changing, using the processing device, the categorization of the test route data and the way the test route data is organized.

8. The method of independent assessments of toll road systems and operations as claimed in claim 2 comprising:
providing, using the storage device, predetermined ranges for fidelity levels;
providing, using the storage device, predetermined ranges for confidence levels;
providing, using the storage device, predetermined criteria for each fidelity level;
providing, using the storage device, predetermined criteria for each confidence level;
providing, using the storage device, predetermined reasons and attributes for an increase or decrease for each fidelity level; and
providing, using the storage device, predetermined reasons and attributes for an increase or decrease for each confidence level.

9. The method of independent assessments of toll road systems and operations as claimed in claim 8 comprising:
receiving, using the communication device, test route data;
checking, using the processing device, if the test route data is from a high-fidelity source;
marking, using the processing device, the test route data with a high confidence rating if it is associated with a high-fidelity source; and
verifying, using a roadside visual device, the test route data provided by the driver.

10. The method of independent assessments of toll road systems and operations as claimed in claim 9 comprising:
checking, using the processing device, if the test route data is from a medium-fidelity source;
comparing, using the processing device, the test route data to the previous test route data associated with a high confidence rating;
marking, using the processing device, the test route data with a high confidence rating if it is similar to the previous test route data associated with a high confidence rating; and
marking, using the processing device, the test route data with a medium confidence rating if it is associated with a medium fidelity source.

11. The method of independent assessments of toll road systems and operations as claimed in claim 10 comprising:
marking, using the processing device, the test route data with a low confidence rating if it is not from a high-fidelity source or medium-fidelity source;
comparing, using the processing device, the test route data to the previous test route data associated with a medium confidence rating; and
marking, using the processing device, the test route data with a medium confidence rating if it is similar to the previous test route data associated with a medium confidence rating.

12. The method of independent assessments of toll road systems and operations as claimed in claim 6 comprising:
processing, using the processing device, the driver location data;
estimating, using a toll transponder device, the time a driver passes through a toll point;
connecting, using the communication device, the processing device to the electronic toll collection system;
scanning, using the processing device, the electronic toll collection system for toll transactions near the estimated toll point;
recording, using a storage device, the error or the anomaly;
generating, using the processing device, a problem alert when multiple anomalies or errors exceeds a threshold quantity;
checking, using the processing device, driver location data and relevant data against toll road data;
marking, using the processing device, the driver location data and relevant data as verified if the driver location data and relevant data matches the associated toll road data; and
generating, using the processing device, a health score for the toll point.

13. The method of independent assessments of toll road systems and operations as claimed in claim 6 comprising:
marking, using the processing device, an owner of a toll billing account;
providing, using the driver mobile device, the processing device access to the toll billing account;
gathering, using the processing device, toll transactions from the toll billing account;
calculating, using the processing device, toll prices based on the toll transactions;
comparing, using the processing device, the toll prices with respect to the toll point associated with the driver location data; and
marking, using the processing device, the toll transaction as verified.

14. The method of independent assessments of toll road systems and operations as claimed in claim 13 comprising:
checking, using toll road lane sensors, if the driver has a toll billing account;
checking, using the processing device, if the driver receives a toll violation notice if the driver has no toll billing account or a driver with a toll billing account has failed to pay the toll bill;
sending, using the communication device, toll violation notice information associated with the toll violation notice to a toll agency;
confirming, using the communication device, the toll violation notice has been received by the driver; and
calling, using the communication device, the electronic toll collection system to check for a toll violation.

15. The method of independent assessments of toll road systems and operations as claimed in claim 13 comprising:
checking, using the processing device, if the toll transaction can be mapped according to the driver location data;
recording, using the processing device, a missing billing transaction when the driver location data has no matching billing transaction;
marking, using the processing device, the driver location data with a low confidence level when the billing transaction has no matching driver location data;
recording, using the processing device, a price discrepancy when the billing transaction does not match the toll prices for the toll point; and
recording, using the processing device, an erroneous billing transaction when the billing transaction is associated with an incorrect license plate or toll transponder device number.

16. The method of independent assessments of toll road systems and operations as claimed in claim 13 comprising:
marking, using the processing device, the drivers with associated toll billing accounts;
assigning, using the processing device, drivers to the at least one test route;
verifying, using the processing device, if the driver has a toll billing account;
verifying, using the processing device, if the driver receives a toll billing statement based on the driver's associated toll transactions;
verifying, using the processing device, the toll billing statement;
verifying, using the processing device, a payment method for tolling billing account associated with the test route;
verifying, using the processing device, if the driver received a payment notice in the mail or electronically;
verifying, using the processing device, if the payment notice received by the driver in the mail or electronically is correct; and
verifying, using the processing device, if a billing transaction is correct.

17. The method of independent assessments of toll road systems and operations as claimed in claim 16 comprising:
recording, using the processing device, a deficiency;
prompting, using the driver mobile device, the driver to call the at least one toll road agency customer service channel;
verifying, using the processing device, if the at least one toll road agency customer service channel was contacted;
verifying, using the processing device, if an issue is resolved;
recording, using the storage device, unresolved customer service issues; and
recording, using the storage device, resolved customer service issues.

18. The method of independent assessments of toll road systems and operations as claimed in claim 17 comprising:
sending, using the driver mobile device, a customer service survey to the driver;
verifying, using the processing device, the completion of the customer service survey;
recording, using the storage device, the customer service survey results;
recording, using the storage device, omitted trip survey answers; and
calculating, using the processing device, a customer service score based on the customer service survey results and omitted customer service survey result answers.

19. The method of independent assessments of toll road systems and operations as claimed in claim 17 comprising:
tracking, using the processing device, the number and types of data sources provided by the driver;
providing, using the processing device, the driver with an incentive based on their data sources; and
sending, using the communication device, a notification with information about the incentive to the driver.

20. The method of independent assessments of toll road systems and operations as claimed in claim 17 comprising:
linking, using the processing device, test route conditions with at least one incentive;
analyzing, using the processing device, at least one test route completed by a driver;
providing, using the processing device, the driver with an incentive based on their test route condition; and
sending, using the communication device, a notification with information about the incentive to the driver.

21. The method of independent assessments of toll road systems and operations as claimed in claim 17 comprising:
tracking, using the mobile device, drives during desired time windows (for example, to increase usage during less busy times);
the driver, using the mobile device, drives a different time (for example, to relieve traffic congestion) as informed by the mobile device;
the driver, using the mobile device, drives at certain speeds (for example, to main traffic near the speed limit) as informed by the mobile device;
the driver, using the mobile device, drives at a slower speed (for example, to observe work zone speed limits) as informed by the mobile device;
the driver, using the mobile device, uses the toll road instead of the available free road as informed by the mobile device;
the driver, using the mobile device, drives to a specific location (e.g., a coffee shop) as informed by the mobile device;
the driver, using the mobile device, drives in a specific lane at a toll point as informed by the mobile device;

22. A system of independent assessments of toll road systems and operations, the system comprising:
a communication device configured for:
providing payment information on completed or uncompleted billing transactions; and
contacting the plurality of toll road agency customer service channels;
a driver mobile device configured for:
downloading a driver application for a driver;
creating a driver account;
providing a license plate, toll transponder number, and vehicle data to the associated driver account; and
providing information about a test route assigned to the driver;
an automobile system configured for:
driving on the test route;
a driver electronic device configured for;
collecting test route data about the test route traveled by the driver;
a processing device configured for:
processing test route data;
generating a plurality of insights based on the test route data;
detecting at least one issue based on the plurality of insights;
evaluating the test route data by a review process;
creating additional test routes for the driver as needed; and
evaluating a billing process by the review process.

23. The system of independent assessments of toll road systems and operations as claimed in claim 22 wherein:
the communication device is further configured for:
assigning the test route to at least one driver;
sending a trip survey to the driver mobile device;
sending trip survey data generated from the trip survey to a web server for processing;
sending the driver location data and relevant data to the web server for processing;
sending alerts to the electronic toll collection system about the errors;
receiving test route data; and
sending toll violation notice information associated with the toll violation notice to a toll agency;
the driver mobile device is further configured for:
opening the driver application;
determining a test route for the driver;
confirming test route completion for the driver;
answering the trip survey about the test route;
connecting to at least one toll road lane sensor;
providing the processing device access to the toll billing account;
prompting the driver to call the at least one toll road agency customer service channels;
prompting the driver to call the at least one toll road agency customer service channels; and
sending a customer service survey to the driver;
the automobile system is further configured for:
conducting the test routes based on the test plans and test cases;
the driver electronic device is further configured for;
testing the test route, a plurality of times;
testing combinations of additional factors; and
capturing driver location data and relevant data;
the processing device is further configured for:
establishing a baseline based on the key performance indicators;
creating test plans and test cases;
organizing the test route data;
creating categories based on the test route data;
running artificial intelligence and machine learning training;
capturing errors from the test route data;
changing the categorization of the test route data and the way the test route data is organized;
checking if the test route data is from a high-fidelity source;
marking the test route data with a high confidence rating if it is associated with a high fidelity source;
checking if the test route data is from a medium-fidelity source;
comparing the test route data to the previous test route data associated with a high confidence rating;
marking the test route data with a high confidence rating if it is similar to the previous test route data associated with a high confidence rating;
marking the test route data with a medium confidence rating if it is associated with a medium fidelity source;
marking the test route data with a low confidence rating if it is not from a high-fidelity source or medium-fidelity source;
comparing the test route data to the previous test route data associated with a medium confidence rating;
marking the test route data with a medium confidence rating if it is similar to the previous test route data associated with a medium confidence rating;
marking an owner of a toll billing account;
gathering toll transactions from the toll billing account;
calculating toll prices based on the toll transactions;
comparing the toll prices with respect to the toll point associated with the driver location data;
marking the toll transaction as verified;
checking if the driver receives a toll violation notice if the driver has no toll billing account or a driver with a toll billing account has failed to pay the toll bill;
checking if the toll transaction can be mapped according to the driver location data;
recording a missing billing transaction when the driver location data has no matching billing transaction;
marking the driver location data with a low confidence level when the billing transaction has no matching driver location data;
recording a price discrepancy when the billing transaction does not match the toll prices for the toll point;
recording an erroneous billing transaction when the billing transaction is associated with an incorrect license plate or toll transponder device number;
marking the drivers with associated toll billing accounts;
assigning drivers to the at least one test route;
verifying if the driver has a toll billing account;
verifying if the driver receives a toll billing statement based on the driver's associated toll transactions;
verifying the toll billing statement;
verifying a payment method for the test route;
verifying if the driver received a payment notice in the mail;
verifying if the payment notice received by the driver in the mail is correct;
verifying if a billing transaction is correct;
recording a deficiency;
verifying if the at least one toll road agency customer service channels was contacted;
verifying if an issue is resolved;
verifying the completion of the customer service survey; and
calculating a customer service score based on the customer service survey results and omitted customer service survey result answers;
a data partner device configured for:
gathering initial results;
analyzing the test route data;
analyzing a billing process;
generating a toll road systems and operations report based on analyses;
defining the test route for the driver;
analyzing the trip survey data and test route data; and
checking for errors and anomalies within the trip survey data and test route data;
a data partner storage device configured for:
generating key performance indicators with at least one data partner source;
a storage device configured for:
recording the test route and test route data;
providing predetermined ranges for fidelity levels;
providing predetermined ranges for confidence levels;
providing predetermined criteria for each fidelity level;
providing predetermined criteria for each confidence level;
providing predetermined reasons and attributes for an increase or decrease for each fidelity level; and
providing predetermined reasons and attributes for an increase or decrease for each confidence level;
a toll collection processing device configured for:
analyzing a toll violation process;
a toll collection storage device configured for:
evaluating a plurality of toll road agency customer service channels;
an electronic toll collection system configured for:
planning a test route around specific toll points;
receiving alerts about test route data;
receiving the test route data;
recording unresolved customer service issues;
recording resolved customer service issues;
recording the customer service survey results; and
recording omitted trip survey answers;
a toll road lane sensor configured for:
checking if the driver has a toll billing account;
